(19) United States
(12) Patent Application Publication
(10) Pub. No.: US 2008/0300991 A1
(43) Pub. Date: Dec. 4, 2008

(54) Operating a site upon an international communications network to cross-refer potential sellers and buyers of real estate to selected real estate agents, rebating a portion of referral fees earned to real estate sellers, or buyers, or both

(76) Inventor: Renato Martinez Openiano, Chula Vista, CA (US)

Correspondence Address: William C. Fuess, Suite 2G, 10951 Sorrento Valley Road, San Diego, CA, 92121-1613, US

(21) Appl. No.: 12/156,878

(22) Filed: Jun. 4, 2008

Related U.S. Application Data
(60) Provisional application No. 60/933,106, filed on Jun. 4, 2007.
(60) Provisional application No. 60/933,917, filed on Jun. 7, 2007.
(60) Provisional application No. 60/999,973, filed on Oct. 23, 2007.

(51) Int. Cl. G06Q 30/00

(52) U.S. Cl. 705/14

(57) ABSTRACT

A referral site operated by a registered real estate broker upon an international communications network system enrolls, most preferably, both seller's and buyer's real estate agents who will provide a referral fee on real estate commissions earned by them from referred sellers, or buyers, or both who do pay said commissions. This referral site is searchable for agents or opportunity by both potential sellers and buyers of real estate. The site earns a referral fee each time an alerted enrolled real estate agent earns a commission, the referral fee preferably being paid directly from escrow. The referral site rebates a portion of this earned referral fee to the seller, or the buyer, of to both the seller and the buyer, as the case may be. The referral site may additionally donate some percentage of its earned referral fees to charity, preferably a charity linked to that community in which the property on which one or more commissions were paid was both sold and purchased.

### REFERENCE TO A RELATED APPLICATION

The present application is related to, and claims benefit of priority of, U.S. Provisional Patent applications Ser. No. 60/933,106 filed Jun. 4, 2007, for “Customer internet self referral internet referral business”; Ser. No. 60/933,917 filed Jun. 7, 2007, for “Customer internet self referral internet referral business (improved)”; and Ser. No. 60/999,973 filed Oct. 23, 2007, for “Customer internet self referral internet business”; all provisional patent applications being in the name of the selfsame inventor of the present application.

### BACKGROUND OF THE INVENTION

1. Field of the Invention

The present invention generally concerns business methods of referring real estate buyers and sellers to real estate agents on a worldwide communications network. The present invention particularly concerns an communications network system for (1) enrolling real estate agents who will provide a rebate on their sales commissions to buyers, to sellers, or to both buyers and sellers of real estate, (2) earning at a network server contingent fees putting both potential sellers and buyers of real estate in contact with real estate agents who will rebate a portion of their sales commissions to sellers, or buyers, or both sellers and buyers of real estate, and (3) arranging for all promised rebates to be duly paid, and also the contingent fees of the network server.

2. Background of the Invention

2.1 The Background to Real Estate Agent Commission Rebates

Housing values in the most areas of the United States greatly increased during 2000-2006 and are still, circa 2008, generally greatly above year 2000 levels. Since real estate agent commissions are based on a percentage of the sale, that means a huge paycheck for agents. Moreover, a real estate agent who takes a listing in an areas or city of relatively low-priced real estate by national standards may actually work harder than an agent in a high-priced area because buyers in those areas and cities are sometimes not so free to spend their money, and may have less of it even relative to the cost of their real estate purchases, the are buyers in high-priced areas and cities. Real estate agents in these high priced areas are likely to take home a commission check that is more than twice as much as agents in other, lower real estate cost, parts of the U.

The other side to the story, however, is that the size of these commissions is no secret. People from all walks of life rushed to take the real estate exam and start cashing those big commission checks after the turn of the millennium. The California Department of Real Estate was overwhelmed with new applications, minting literally thousands of eager new agents each month. The result was, and is, unprecedented competition for the real estate business.

It is not fair to characterize real estate agents as greedy. Recently, however, some agents in some areas have recognized that commissions are no longer in line with the value of the services rendered and have begun for refund (or rebate) a portion of their commission to their clients.

Web sites such a SFBayRebates lets potential buyers find real estate agents who offer commission rebates. In the San Francisco market rebates may just plain make sense. First they place a limit on commissions that have strongly arguably become excessive, redirecting some of the money to where it belongs: namely, to the seller and/or the buyer. Second, rebates give real estate agents a legitimate way to compete for business.

Real estate commission rebates are neither illegal nor against the rules, although some people with a vested interest in high commissions may say so. These people tend to be real estate agents making quite a bit of money. A legal examination of the California real estate law indicates that commission rebates are completely legal and are a legitimate way for agents to compete for business. In fact, circa 2008 there are some brokerage companies like Ziprealty that make rebates a standard part of their business.

Interestingly, some other states have tried make rebates illegal. Recently, the State of Kentucky was sued by the Federal Government on anti-trust grounds because of its state law prohibiting rebates. Kentucky and the U.S. Department of Justice have now reached an agreement which allows agents in that state to offer rebates. It now looks, circa 2008, that commission rebates are here to stay, active or slow markets.

Thus, by using the aforementioned “SFBayRebates” web site, the prospective purchaser can find a real estate agent who will provide the highest level of professional service, while still offering a commission rebate.

2.2 More Background to Real Estate Agent Commission Rebates

Still more information about the national trend toward real estate commission rebates appeared in the Wall Street Journal, THE JOURNAL REPORT: HOME INVESTMENTS for Jun. 14, 2004, available from the Dow Jones WebReprint Service. In the article “Cutting the Commission Pass the word: Your broker's fee really is negotiable” by James R. Hagerty, Staff Reporter of THE WALL STREET JOURNAL, it was explained that after selling a home, real-estate agents often traditionally gave clients a gift, such as a scented candle or decorative plate. However, one “Jeffrey D. Thomas received something more memorable: a check for more than $10,000.

“Mr. Thomas is the kind of customer most agents don't want to meet. He believes commissions on home sales are way too high, particularly for people like himself who have bought and sold homes before and are willing to help steer the transaction. “It's not rocket science,” says Mr. Thomas, a lecturer at the Massachusetts Institute of Technology.

“So he found an agent, Bill Wendel, who works by the hour, instead of taking a percentage of the sale price as most agents do. With Mr. Wendel's help, Mr. Thomas bought a $537,400 home in Arlington, Mass., last year. The price included a 2.5% commission, or $13,435, for the agent representing the buyer. But Mr. Wendel, who has been experimenting for years with new ways to sell real estate, turned his cut over to Mr. Thomas. In turn, Mr. Thomas paid Mr. Wendel $2,960 for 29.6 hours of work at $100 an hour. That left Mr. Thomas with a net rebate of $10,475.

“Unlike Mr. Thomas, most people who buy and sell houses still pay sizable commissions. Typically, the amount, split between agents for the buyer and seller, is around 5% of the sale price, though the going rate is as much as 7% in some areas. But as his experience shows, there are alternatives. Some traditional real-estate firms are becoming more open to negotiating a commission amount. Others openly compete on the basis of discounts. Meantime, a small number of firms, including Mr. Wendel's Real Estate Cafe in Cambridge, Mass., charge fees based on the time spent working for the customer or the services provided. Even the for-sale-by-owner market is seeing new companies that provide services that facilitate the selling process, including online ads and yard signs.

“The big secret is out: Real-estate commissions are negotiable,” says Mary LaMeres-Pomin, president of Assist-2-Sell Inc., a Reno, Nev., company that franchises discount firms offering a variety of home-selling formulas, including flat fees.

“When buyers approach a traditional real-estate agency, they are often assured that the agent's help is free. That's true in the sense that the home buyer doesn't normally pay the agent. But the service isn't really free because home sellers factor in the cost of commissions when they price their homes. In fact, some sellers are willing to lower the price if you show up without an agent.

Agents' Advantages are several. Still, the traditional system has its advantages. For one, you don't pay anything if the agent doesn't find you a home you want to buy and wrestle the deal all the way to closing. If you're paying by the hour, you could spend a lot of money even if you don't end up buying a home.”

Choices for people buying or selling houses boil down to the following: In a standard agreements agents for buyer and seller each take commissions of roughly 2.5% to 3%, paid out of the seller's proceeds. Discount: Agents work for 2% or sometimes less.

In a rebate either, or both, agent rebates part of their commission to the seller or buyer, as the case may be. Variants available through LendingTree and Costco.

In a fee for services arrangement the agent charges an hourly fee for doing such things as showing houses, advising on prices and preparing documents.

Finally, in a “For Sale By Owner” situation the owner/seller does without an agent but may buy services from firms that cater to this type of sale. The Buyer can choose whether to use an agent or do without one and ask for a lower price.

2.3 Arguments for and Against Rebating a Portion of Real Estate Commission Fees

For sellers, real estate agents have at least a few compelling arguments. One of them is: “We know more than you do about marketing a house and will fetch a much higher price than you could on your own.” That claim is impossible to verify but probably true in many cases. Another effective pitch: “We screen the potential buyers, making it less likely that criminals will get a free tour of your home.”

Good agents also can provide lots of information about neighborhoods, handle negotiations and ensure that environmental hazards are checked out and regulations followed. Most people want “someone who knows all the technicalities to walk them through the process,” says Walt Molony, a spokesman for the National Association of Realtors, a trade group with about one million members.

That kind of hand-holding has grown increasingly expensive as house prices have soared. Real Trends, an industry publication, estimates that the average total commission—split between agents for the buyer and seller—is about 5.1%. On a $500,000 house, that means agents for the buyer and seller are divvying up about $25,500. The agents make the same amount whether it's a long and difficult transaction or a quick sale.

Such high prices are not set in stone, however. And the industry is opening up to different ways of doing business—and of getting paid.

According, many buyers, and even some sellers, are asking for a discount

Even for people who choose more traditional real-estate agencies, it's always advisable to ask for a discount. While some agents refuse to work for less than a certain percentage, others are hungry enough to compromise. Some Internet real-estate services, such as HomeGain.com Inc., Emeryville, Calif., allow you to solicit online pitches from a variety of agents and compare things like experience and commissions. Brad Inman, chief executive officer of HomeGain, says many people find it more comfortable to dicker over commissions online than in person.

Jeff Tuck, owner of Option 1 Realty Inc. in Richmond, Va., says the commission should depend on the circumstances. If a seller represented by his firm helps find a buyer during the listing period, the commission is 2.95%. If Option 1 finds a buyer, it's 3.95%. And if an outside agent provides the buyer, the fee could be as much as 4.95%, depending on the amount of compensation the seller is willing to give a buyer's agent.

Getting something back—a rebate—is also available to real estate sellers and buyers in most areas. Some agents are willing to give buyers a rebate on part of the commission they earn. Daniel Ruben Odio, who owns DROdio.com Realty in Falls Church, Va., gives a rebate of 2% of the purchase price on newly built homes and 1% on resale homes. He also runs a service called RebateReps.com, which locates agents in other parts of the country who are willing to offer rebates. INest Realty Inc., Bloomingdale, Ill., which is licensed in 18 states, offers 1% rebates on new homes.

LendingTree, a unit of Internet travel and marketing company InterActiveCorp, offers rebates or other rewards for people who use agents recommended by the company, which, in turn, earns a referral fee from those agents. LendingTree's offers include gift cards from Home Depot Inc. or American Express Co., valued at as much as $2,000, depending on the price of the home. LendingTree offers a rebate if you sign up with a real-estate agent through a service offered jointly by Costco Wholesale Corp. and LendingTree. It also offers mileage awards with several airlines, but customers must enter the program through those partners to qualify. Some states prohibit or restrict rebates.

But even with a rebate, do commissions make sense?

John Tuccillo, an industry consultant and former chief economist of the Realtors association, notes that lawyers who draw up wills don't demand 6% of your net worth; their charges tend to be based on how many hours they have to work. Mr. Tuccillo says more real-estate agents will follow that example in the future, though he expects that commissions will remain the dominant form of payment.

The National Association of Real Estate Consultants promotes the fee-for-service approach and says it has about 1,200 members. Hourly charges by members typically range from $75 to $150, says Julie Garton-Good, founder of the association.

In fee-for-service arrangements, customers need to figure out how much help they require. Mr. Thomas looked at homes online and drove past the ones that seemed most interesting before calling on Mr. Wendel to get appointments to tour some of them. The agent also advised on market conditions and helped negotiate the offer, among other tasks. Mr. Thomas didn't find it necessary to have an agent with him during the inspection or closing.

Help-U-Sell Real Estate, Syosset, N.Y., runs a national chain of franchisees that charge fees based on the level of service required. The company says its franchisees typically charge a flat fee of about $2,950 to advertise a home for sale, provide yard signs, advise on the offering price, negotiate with potential buyers and guide the sale through closing. Under that plan, the sellers of the house, rather than a Help-U-Sell agent, show the property to prospective buyers. For an additional fee of around $2,950, Help-U-Sell agents also will show the home.

Meantime, for sellers who decide to do without an agent, there are companies that offer services to facilitate the process. New York-based ForSaleByOwner.Com charges fees for listing homes on its Web site and in its listings catalogs. Prices range from about $80 a month for a basic ad to $699 for a deluxe package, which includes yard signs and insertion into your local multiple-listing service, a database for real-estate agents.

“The consumer understands that 6% [in commissions] is crazy, and they want an alternative,” says Colby Sambrotto, the company's chief operating officer.

2.4 Real Estate Rebates and the Law

In the article “Justice Dept. And FTC “Trust-Busters” Zero In On State Real Estate Regulators” by Kenneth R. Harney appearing in Realty Times it is explained that in a new, get-tough campaign, the U.S. Department of Justice and the Federal Trade Commission have warned, or sued, real estate regulators in three states to avoid adopting anti-competitive rules that discriminate against non-traditional real estate brokers who offer either commission rebates or limited service, discount-priced services to consumers.

The Justice department and the FTC sent a joint warning letter to the Texas Real Estate Commission urging it to reject a pending rule change on the commission's docket to redefine the minimal, core services a Texas-licensed broker must offer a home seller including assistance in negotiating or evaluating buyers' offers on the property.

Adopting such a rule, according to Justice and the FTC, would “harm Texas consumers by reducing their choices (in brokerage representation) and likely raising prices without any countervailing benefits.”

“Limited service brokers are growing rapidly in Texas, and around the country, because they provide greater choices and can save consumers thousands of dollars on a single home sale,” said R. Hewitt Pate, U.S. Assistant Attorney General in charge of anti-trust litigation.

Texas Real Estate Commission administrator, Wayne Thorburn said the purpose of the proposed rule is to prevent situations where a seller using a limited-service broker might be left with no effective representation at crucial stages during a sale transaction. The rule would, for example, eliminate the possibility that a broker might charge a seller a flat $500 fee and say, “I'll list your property, put you on the MLS, I'll give you a sign for the front yard, and then you're on your own, good luck.”

Though the Justice department and the FTC didn't threaten any specific legal action against the Texas realty commission, there may not have been a need to: Justice sued the Kentucky Real Estate Commission March 31, for allegedly limiting free competition in the marketplace by prohibiting commission rebates by brokers.

In its suit, the Justice department said the Kentucky commission's ban “is a violation of the anti-trust laws that inflicts higher prices on Kentucky consumers.” Federal anti-trust laws “protect consumers against restrictions on competition,” said Pate, “even when they are adopted by state-created entities like the Kentucky Real Estate Commission.”

The third state to come under federal fire recently was Oklahoma, where the legislature was on the verge of considering a new statutory definition of minimal core service standards for brokers, similar to the draft regulations pending in Texas. In a virtually unprecedented step, the Justice department intervened to warn the legislature not to restrict consumers' choices by eliminating competition by discount-cost, limited service brokers.

In an interview, assistant attorney general Pate confirmed that the recent, rapid-fire moves against the states is part of an “advocacy” campaign by the Bush administration to promote free competition in the booming real estate market. Pate would not comment on strategy beyond the moves already made, but said the department is concerned by reports from other states about allegedly anti-competetive moves by realty regulators. For example, between 11 and 16 states currently prohibit or limit commission rebates by realty brokers. Pate would also not comment about his division's investigation of the NAR's “VOW” policies affecting online access to MLS data, other than to say the probe is “intensive” and ongoing.

2.5 More on Real Estate Rebates and the Law

In the matter of UNITED STATES OF AMERICA, Plaintiff, v. KENTUCKY REAL ESTATE COMMISSION, Defendant, Civil Action No. 3:05-cv-00188-S in the UNITED STATES DISTRICT COURT FOR THE WESTERN DISTRICT OF KENTUCKY, the United States sued the State of Kentucky under the Antitrust Law, Section 1 of the Sherman Act, as amended, 15 U.S.C. §1, for restricting the rebating of real estate commissions. In an AMENDED FINAL JUDGMENT the Court held that Defendant Kentucky Real Estate Commission was “enjoined from, directly or indirectly, or through any Regulation, Disciplinary action or other conduct: [1] Entering into, continuing, maintaining, or renewing any agreement, contract, or Regulation to fix, establish, raise, stabilize, suppress, eliminate, regulate, or maintain the level of commissions, discounts, Rebates, Inducements, or the Licensee Price; [2] prohibiting, restricting, impeding, or discouraging any Licensee from Price Advertising or from offering any Licensee Price, discounts, Rebates, or Inducements; [3] Investigating any Licensee for Price Advertising or for offering any Licensee Price, discounts, Rebates, or Inducements; [4] Threatening or taking any Disciplinary Action against any Licensee for Price Advertising or for offering any Licensee Price, discounts, Rebates, or Inducements; [5] Enforcing the Rebate Ban; or [6] Inducing, urging, encouraging, or assisting any person or organization to take any of the actions prohibited by this Section of the Amended Final Judgment.

3. Web Services Concerning Real Estate Commissions

3.1 A First Existing Directory of Real Estate Agents Offering Rebates on their Commissions

Some existing web sites, circa 2008, permit a user to search for a seller's, or a buyer's, or any real estate agent in a user-designated region or city. Such a function leads neither a seller, nor a buyer, to a real estate agent offering a rebate on the agent's commission(s).

Meanwhile, a “First Directory of Real Estate Agents Offering Commission Rebates” is present, circa 2008, on the world wide web under the name “SFBayRebates”.

Commission Rebates are for both Buyers and Sellers are listed. If you are a seller, you can get a rebate and/or a discount on the commission you pay by negotiating with your agent. If you are a buyer, you can receive a payment from your agent after the transaction closes. This comes from the commission paid by the seller and can give you thousands of dollars to get set up in your new home.

The site asks the questions: Are rebates legal? Can real estate sales person licensees offer rebates? Do I have to be a broker?

While not offering legal advice, the site advances that, as intelligent laymen, the have examined the California real estate law and can find no reason why any licensee cannot offer a commission rebate.

The real estate law makes it clear that sales person licensees can receive commissions only through their broker. However, it says nothing about licensees paying a rebate to the principals in the transaction.

The State of Kentucky, does in fact, have regulations that prohibit rebates. Those regulations were recently overturned when the U.S. Dept. of Justice sued the state on anti-trust grounds. The Kentucky Real Estate Commission and the federal government have now reached an agreement that allows rebates for all licensees.

The agreement clearly states that it applies to “any person who is licensed by Defendant under chapter 324 of the Kentucky Revised Statutes or any future recodification thereof and legally can perform acts of real estate brokerage, and any person who legally can perform acts of real estate brokerage while acting under the supervision of a licensed broker.” (our emphasis).

The jurisprudential impact of the Kentucky decision, and the rationale of the decision itself, would tend to suggest that even if some obscure provision in California law which prohibits rebates has been missed, such a provision would not stand up to a Federal challenge.

Of course, if you are a sales person licensee, it is possible that your broker might try to stop you from offering a rebate. However, most sales persons operate under an independent contractor agreement that specifically prohibits the broker from telling you how to go about marketing your services. In any case, the rebate would be coming out of your individual commission, rather than the broker's.

Commission rebates appear to be a legitimate way for all licensees to compete for real estate business.

For example, a 15% Rebate on Real Estate Commission on a $200,000 sale or purchase price×your side of the transaction (3.5% commission), equals $7,000×15% discount (discount given in escrow and can be applied toward closing cost). Total savings equals $1050.

The “SFBayRebates”.web site offers (1) placement with qualified Realtor and/or other real estate industry professional (Anywhere in the US, and some overseas countries); (2) consultation with the buyer or seller, and (3) out-of-town and out-of-state relocation services

The present invention will be seen to differ by teaching how to make a viable business out of advising consumers on access to real estate commission rebates.

3.2 A Second Existing Directory of Real Estate Agents Offering Rebates on their Commissions

Circa 2008 Costco operates web site, and service, for placing potential sellers, buyers, or both sellers and buyers of real estate into contact and contract with seller's, buyers, or both seller's and buyer'real estate agents. Said real estate agents are particularly, and only, those ones who are willing to rebate a portion of their seller's agent, buyer's agent, or both the seller's and the buyer's agent's(s') real estate sales commissions earned to the seller, the buyer, or both, as the case may be.

The web site contains, and refers, only real estate agents who will provide a rebate on their earned sales commissions to buyers, to sellers, or to both buyers and sellers of real estate. These enrolling real estate agents further contract with the referral site to pay to the site yet a further, separate, portion of their commissions earned on any real estate transactions closed while representing sellers, or buyers, or both sellers and buyers referred to them through the site;

In operation the Costco referral website (1) provides to identified potential sellers of real estate a searchable index of real estate agents providing a rebate to seller on agent's real estate sales commissions earned, and also (2) provides to identified potential buyers of real estate a searchable index of real estate agents providing a rebate to buyer on buyer's real estate sales commissions earned. Potential sellers and buyers of real estate are thus expected to advantage themselves of the search capabilities of the site in their own self interest(s), identifying real estate agents of opportunity that, in providing a rebate on their earned commissions, might render their services for less money.

The method of the present invention will be seen to differ in that, inter alia, it is the referring web site, and neither the buyer's and/or the seller's real estate agent(s), that pays a rebate to the seller of purchaser as the case may be.

### SUMMARY OF THE INVENTION

The present invention contemplates a business method, performed by a registered real estate agent serving as a middleman, offering searchable directories upon a worldwide communications network for putting potential sellers and buyers of real estate into contact with real estate agents that have agreed in advance to pay a referral fee to the registered agent (as is permissible in all jurisdictions). If the sellers and/or buyers referred to the real estate agents ultimately sell of buy real estate regarding which commissions are earned by the seller's agent(s), buyer's agent(s), or both (all), then one or more referral fees is paid to the referring registered agent operating the searchable directory. From this (these) referral fee(s) the registered agent pays a rebate to the seller, the buyer, or both. A further stipend may be paid to charity, particularly a local charity in the location where the real estate sold and purchased is located.

Potential sellers and buyers of real estate are thus induced to use the services of the network-located searchable directory, and method, for both (1) pecuniary self interest in the form of a monetary rebate on real estate agent commissions paid, and, potentially (2) a local charitable contribution.

1. A business method of placing a potential seller of real estate into contact with a buyer's real estate agent, and paying a rebate if this agent earns a commission on an actual real estate purchase

Accordingly, in one of its aspects the present invention is embodied in a business method of providing a buyer of real estate with a partial rebate of any buyer's real estate agent's commissions paid in a qualifying real estate transaction

The method commences by enrolling at a site upon an international communications network other, buyer's, real estate agents who will pay a referral fee to the site upon their earning of buyer's real estate agent's sales commissions on sales made to real estate buyers referred to them by the site.

The site is then operated to refer identified potential buyers of real estate to enrolled buyer's real estate agents meanwhile that these selected enrolled buyers's real estate agents are alerted from the site—such as by telephone text message and/or e-mail, as to all referrals made of them, and to them, of potential buyers of real estate.

By this sequence a referral fee is collected by the referral site upon all real estate transactions in which an enrolled alerted buyer's real estate agent collects a commission on a sales of real estate to a buyer who was referred to this enrolled real estate agent by the referral site.

Finally in the method, the referral site rebates to a referred real estate buyer a portion of a referral fee earned from the enrolled alerted buyer's real estate agent in respect of a qualifying real estate purchase made by the referred real estate buyer.

This method can be enhanced, and expanded, for further for providing a seller of real estate with a partial rebate of seller's real estate agent's commissions paid in a real estate transaction. In this case the method further includes enrolling at the referral site still other, seller's, real estate agents who will pay a referral fee to the referral site upon their earning of seller's real estate agent's sales commissions on listings made for real estate sellers referred to them by the referral site.

The referral site is then operated so as to refer identified potential sellers of real estate to enrolled seller's real estate agents, meanwhile alerting enrolled sellers's real estate agents as to all referrals made of them, and to them, of potential sellers of real estate.

Like as before, a referral fee is collected by the referral site upon all real estate transactions in which an enrolled alerted seller's real estate agent collects a commission on a sale of real estate by a seller who was referred to this enrolled real estate agent by the referral site.

Further like as before, the referral site rebates to a referred real estate seller a portion of a referral fee earned from the enrolled alerted seller's real estate agent in respect of a qualifying real estate sale made by the referred real estate seller.

In the basic, and the expanded, methods the fee of the referral site—contracted with the buyer's, of the seller's, or both the buyer's and the seller's real estate agent(s)—is preferably not fixed, but is rather preferably a percentage of the real estate agent's earned commission. This referral fee (of the referral site that is a percentage of the real estate agent's earned commission is preferably within the range of 20% to 40% of said real estate agent's overall earned commission. Moreover, the rebate paid to the buyer, or the seller, or both, by the referral site is [preferably within the range of 70% to 90% of the referral fee collected by the referral site from the seller's real estate agent's earned commission. This thus makes that the overall rebate is preferably within the range of 14% to 36% of said buyer's, or seller's, or both buyers' and sellers real estate agent's overall earned commission(s).

The method further preferably includes, including between the enrolling and the operating steps,

The method further preferably includes, including between the enrolling and the operating steps, the step of advertising the referral site as providing a rebate to sellers, or to buyers, of real estate who do sell, or purchase, real estate using seller's, or buyer's, brokers referred to them by the referral site.

The referral site may also, optionally, offer and make a charitable donation, preferably to a charity local to where the real estate is sold and purchased, in memorialization of the transaction, and so as to incur local good will for both seller and buyer.

The enrolling is preferably at the referral site of a licensed real estate broker or agent.

2. A business method of providing a seller of real estate with a partial rebate of any seller's real estate agent's commissions paid in a qualifying real estate transaction

In another of its aspects the present invention is embodied in a business method of providing a seller of real estate with a partial rebate of any seller's real estate agent's commissions paid in a qualifying real estate transaction.

The method starts with the enrolling at the site of a registered licensed real estate agent upon an international communications network other, seller's, real estate agents who will pay a referral fee to the site upon their earning of seller's real estate agent's sales commissions on sales made to real estate sellers referred to them by the site.

The site is the operated to refer identified potential sellers of real estate to enrolled seller's real estate agents meanwhile to alerting (from the referral site) enrolled seller's real estate agents as to all referrals made of them, and to them, of potential sellers of real estate.

A referral fee is collected by the referral site upon all real estate transactions in which an enrolled alerted seller's real estate agent collects a commission on a sale of real estate by a seller who was referred to this enrolled seller's real estate agent by the referral site.

Finally, a rebate is paid from the referral site to a referred real estate seller. This rebate preferably consists of a portion of a referral fee earned from the enrolled alerted seller's real estate agent in respect of a qualifying real estate sale made by the referred real estate seller.

This method may be expanded to further providing a buyer of real estate with a partial rebate of buyer's real estate agent's fees paid in a real estate transaction like as to the method of section 1 was expanded to add the seller, and seller's real estate agents, mutatis mutandis.

As before, the enrolling is preferably at the referral site of a licensed real estate broker or agent.

3. A business method of providing a buyer of real estate, a seller of real estate, or both with a partial rebate

In yet another of its aspects the present invention is embodied in a business method of providing a buyer of real estate, a seller of real estate, or both with a partial rebate of, respectively, buyer's real estate agent's commissions paid, seller's real estate agent's commissions paid, or both, in a real estate transaction.

The method includes enrolling at a site upon an international communications network seller's, or buyer's, or both seller's and buyer's real estate agents who will pay a referral fee to the site upon their earning of a respective seller's, or buyer's, or both seller's and buyer's real estate agent's sales commissions respectively on sales made to, and purchases made by, sellers and buyers of real estate that are referred to these agents by the site.

The referral site is then operated to refer identified potential sellers of real estate to enrolled seller's real estate agents, and identified potential buyers of real estate to enrolled buyer's real estate agents. Meanwhile an alert, and a cross-referral, of the potential sellers and/or buyers is made to the enrolled seller's and/or buyer's real estate agents.

A referral fee is collected by the referral site upon all real estate transactions in which (1) an enrolled alerted seller's real estate agent collects a commission on a sale of real estate by a seller who was referred to this enrolled seller's real estate agent by the referral site, (2) an enrolled alerted buyer's real estate agent collects a commission on a purchase of real estate by a buyer who was referred to this enrolled buyer's real estate agent by the referral site, or transactions in which (3) both seller's agents and buyer's agents collect commissions from respective sellers and buyers of real estate.

The referral site then rebates to a referred real estate seller, or buyer, or both, a portion of a referral fee earned from the enrolled alerted respective seller's real estate agent, buyer's real estate agent, or both, in respect of a qualifying real estate sale made by the referred respective real estate seller, or buyer, or both.

By this method a real estate seller, or buyer, or both may receive a rebate on the commissions of a respective seller's real estate agent, buyer's real estate agent, or both seller's and buyer's real estate agent from, and through, the referral site.

The enrolling is preferably at the referral site of a licensed real estate broker or agent.

These and other aspects and attributes, of the present invention will become increasingly clear upon reference to the following specification and accompanying drawings.

### BRIEF DESCRIPTION OF THE DRAWINGS

FIGS. 1 and 2 are flow charts showing the steps of a preferred embodiment of the invention.

### DESCRIPTION OF THE PREFERRED EMBODIMENT

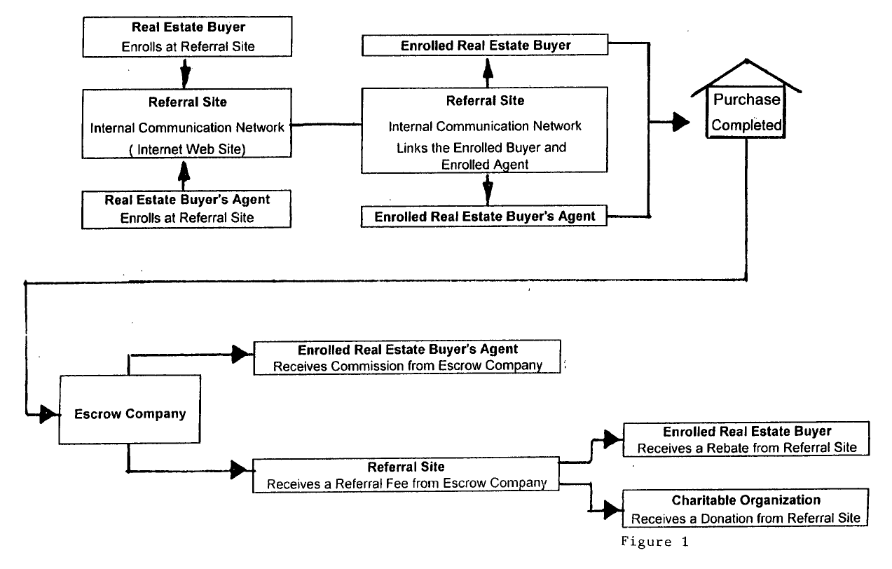

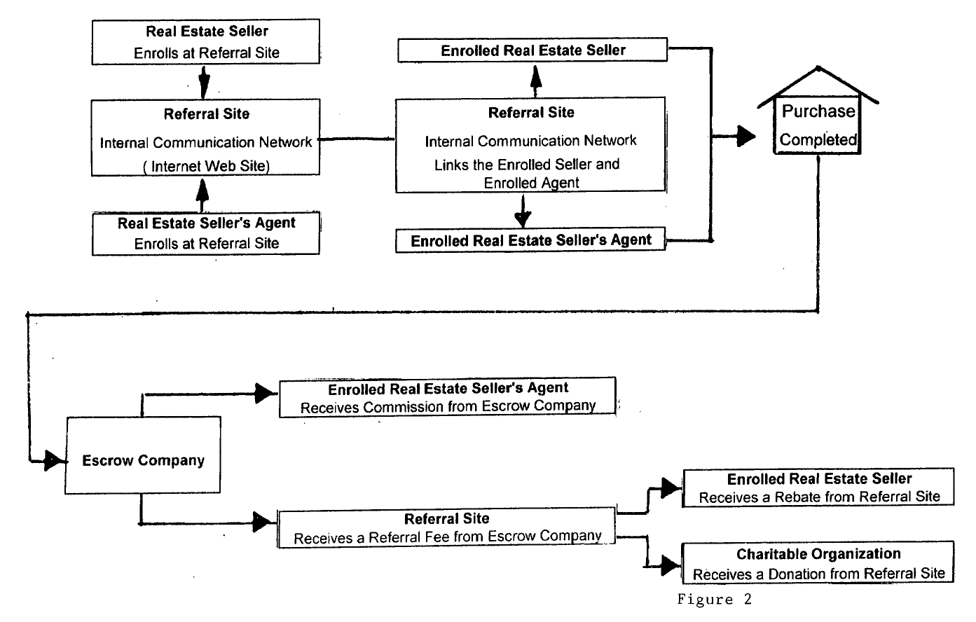

A flow chart of the steps of a preferred embodiment of the invention for buyers is shown in FIG. 1, and for sellers in FIG. 2.

Real estate agents are urged to enroll at a referral site upon a worldwide communications network, commonly the world wide web of the Internet.

Both buyers and sellers are then urged to use the referral site, including by advertising. They are induced to so by the promise of cash rebates on qualifying real estate transactions. These rebates may become increasingly important. The referral site offers real estate agents an opportunity to reach clients who are savvy and actively looking for a rebate.

There are a number of factors that make our service especially attractive to real estate agents:

The referral site charges a referral fee only completion of a agent-commission-producing real estate transaction. There are preferably no advance per-lead or other transaction fees of any kind. There is normally no limit to the number of referrals that any one enrolled agent can receive.

The agents directory typically lists the agent's phone number, email address and website (if the agent have one). Referred clients are urged to immediately contact the agent of their choice directly.

The directory gives real estate agents an opportunity to contact only those clients who are actively seeking them or someone like them. Moreover, the real estate agent need not announce a rebate on his or her own website and offer it to all clients.

As with any web directory are referral service, the order in which agents are listed is critical to the number of leads you will potentially receive. The directory lists typically lists, ranks and refers agents in the following order, and this does not change over time.

Agents in the specific city/area that the client searches for are listed and referred first, in the order in which the agents signed up for the directory and referral service.

Agents in neighboring areas are listed and referred second if necessary, again in the order in which the agents signed up for our directory.

This means that agents who sign up for the directory are referral service early on will maintain the top positions as long as they continue their participation.

Upon enrolling for the service, an agent will be asked to fill out a form with his or her directory information. The agents listing will normally appear in the directory as soon as the referral web site's staff reviews the information—generally within one business day.

Like existing real estate agent contact services the system and service of the present invention are directed to aiding the real estate agent by putting powerful contact and referral forms to work on the referral website almost instantly! By these contact and referral forms, internet leads are preferably delivered instantly to the agents cell phone via text message. The system will also normally, and preferably, forward leads to multiple email addresses and automatically send the client a personalized thank you/confirmation message.

This scenario is already recognized in the prior art to be superior to an agent's website alone which website includes the agent's email address. This is because a home owner looking for a listing agent may visit the agent's website, see the agent's email address, and send the agent a message expressing his interest. However, the home owner may then visit another agent's website—the website of an agent using the agent contact and referral service! The home owner then and there fills out yet another, easy-to-use, contact form. However, in this case using the agent contact and referral service, the home owner immediately receives a followup email, ostensibly from the other agent which addresses him by name. This e-mail is in fact generated by the contact and referral service. Moreover, this second agent instantly receives a text message on his or her cell phone giving the home owner's name, phone number and interest in selling a home. The second agent normally calls the home owner as quickly as possible, and secures the listing and the business.

The contact and referral forms are easy to use and the referral website generally has a professional appearance. Clients are more likely to use the referral service than they are to take the trouble to write an email message to an agent.

The referral forms make it easy for clients to refer friends and other people they know. Finally, if state regulations allow it, the referral site pays a rebate to the real estate seller and/or buyer upon the conclusion of a qualifying transaction.

Thus the method of the present invention includes enrolling at a referral site on an international communications network enrolled real estate agents who have agreed to pay a referral fee to the referral web site on their earned sales commissions to buyers, to sellers, or to both buyers and sellers of real estate. These enrolling real estate agents further contract with the referral site to pay this referral fee on their commissions earned on any real estate transactions closed while representing sellers, or buyers, or both sellers and buyers referred to them through the site;

In the method the referral site is operated (1) to provide to identified potential sellers of real estate a searchable index of real estate agents providing a rebate to seller on agent's real estate sales commissions earned, and also (2) to provide to identified potential buyers of real estate a searchable index of real estate agents providing a rebate to buyer on buyer's real estate sales commissions earned. Potential sellers and buyers of real estate are thus expected to advantage themselves of the search capabilities of the site in their own self interest(s), identifying real estate agents of opportunity that, when used, qualify them for a cash rebated directly from the referral site.

In the method the referral site alerts, preferably and typically immediately by cellular telephone text message and/or e-mail, enrolled seller's agents to all referrals made of them to potential sellers of real estate, and also enrolled buyer's agents to all referrals made of them to potential buyers of real estate. It is up to said alerted enrolled agents to contact, and to contract with, the potential buyers and sellers. Most will undertake to do so quickly, and within minutes.

Thereafter the referral site participates in escrowed sales of real estate in which are involved

The referral site is involved to verify, and to ensure, that said enrolled agents do indeed pay the promised portion of their sales commissions as a referral fee to the referral site. The referral site then pays a lessor amount, normally 70% to 90%, of this referral fee as a rebate to qualified sellers, to buyers, or both sellers and buyers at closing of the escrowed real estate. The referral site concurrently arranges at escrow for its own contracted fee(s) to be paid from the earned commission of any contracted alerted real estate agent payable to that agent at escrow.

The fee of the referral site contracted with the real estate agents is preferably not fixed, but is rather a percentage of the agents earned commission.

The fee of the referral site that is preferably a percentage of the agents earned commission is preferably 25% to 40% of the agents earned percentage of his/her earned commission.

As stated, the “take” of the referral site is most preferably 20% to 40% of this percentage of the enrolled alerted real estate agent's earned conrnission. Of this amount preferably from 70% to 90%, is rebated to the real estate seller or buyer, or both. The general flow of this process is self-explanatory in FIG. 1.

What is claimed is:

1. A business method of providing a buyer of real estate with a partial rebate of any buyer's real estate agent's commissions paid in a qualifying real estate transaction, the method comprising:
enrolling at a site upon an international communications network other, buyer's, real estate agents who will pay a referral fee to the site upon their earning of buyer's real estate agent's sales commissions on sales made to real estate buyers referred to them by the site;
operating the site to refer identified potential buyers of real estate to enrolled buyer's real estate agents; while
alerting from the referral site enrolled buyers's real estate agents as to all referrals made of them, and to them, of potential buyers of real estate;
wherein a referral fee is collected by the referral site upon all real estate transactions in which an enrolled alerted buyer's real estate agent collects a commission on a sale of real estate to a buyer who was referred to this enrolled real estate agent by the referral site; and
rebating from the referral site to a referred real estate buyer a portion of a referral fee earned from the enrolled alerted buyer's real estate agent in respect of a qualifying real estate purchase made by the referred real estate buyer.

2. The method according to claim 1 further for providing a seller of real estate with a partial rebate of seller's real estate agent's commissions paid in a real estate transaction, the method further comprising:
enrolling at the referral site still other, seller's, real estate agents who will pay a referral fee to the referral site upon their earning of seller's real estate agent's sales commissions on listings and sales made for real estate sellers referred to them by the referral site;
operating the referral site to refer identified potential sellers of real estate to enrolled seller's real estate agents; while
alerting from the referral site enrolled sellers's real estate agents as to all referrals made of them, and to them, of potential sellers of real estate;
wherein a referral fee is collected by the referral site upon all real estate transactions in which an enrolled alerted seller's real estate agent collects a commission on a sale of real estate by a seller who was referred to this enrolled real estate agent by the referral site; and
rebating from the referral site to a referred real estate seller a portion of a referral fee earned from the enrolled alerted seller's real estate agent in respect of a qualifying real estate sale made by the referred real estate seller.

3. The method according to claim 2 wherein the fee of the referral site contracted with the seller's real estate agent is not fixed, but is rather a percentage of the seller's real estate agent's earned commission.

4. The method according to claim 3 wherein the referral fee of the referral site that is a percentage of the seller's real estate agent's earned commission is within the range of 20% to 40% of said seller's real estate agent's overall earned commission.

5. The method according to claim 4 wherein the rebate paid to the seller by the referral site is within the range of 70% to 90% of the referral fee collected by the referral site from the seller's real estate agent's earned commission, and is thus within the range of 14% to 36% of said seller's real estate agent's overall earned commission.

6. The method according to claim 1 wherein the fee of the referral site contracted with the buyer's real estate agent is not fixed, but is rather a percentage of the buyer's real estate agent's earned commission.

7. The method according to claim 6 wherein the referral fee of the referral site that is a percentage of the buyer's real estate agent's earned commission is within the range of 20% to 40% of said buyer's real estate agent's overall earned commission.

8. The method according to claim 7 wherein the rebate paid to the buyer by the referral site is within the range of 70% to 90% of the referral fee collected by the referral site from the buyer's real estate agent's earned commission, and is thus within the range of 14% to 36% of said buyer's real estate agent's overall earned commission.

9. The method according to claim 1 further comprising, including between the enrolling and the operating, the step of:
advertising the referral site as providing a rebate to buyers of real estate who do purchase real estate using buyer's brokers referred to them by the referral site.

10. The method according to claim 1 further comprising:
making a charitable donation from the referral site to a charity local to where the real estate is sold and purchased, the donation being in memorialization of the real estate transaction, and so as to incur local good will for both real estate seller and real estate buyer.

11. The method according to claim 1
wherein the enrolling is at the referral site of a licensed real estate broker or agent.

12. A business method of providing a seller of real estate with a partial rebate of any seller's real estate agent's commissions paid in a qualifying real estate transaction, the method comprising:
enrolling at the site of a registered licensed real estate agent upon an international communications network seller's real estate agents who will pay a referral fee to the site upon their earning of a seller's real estate agent's sales commissions on a listing made for, and a sale made by, a real estate seller who is referred to the seller's real estate agent by the site;
operating the site to refer identified potential sellers of real estate to enrolled seller's real estate agents; while
alerting from the referral site enrolled seller's real estate agents as to all referrals made of them, and to them, of potential sellers of real estate;
wherein a referral fee is collected by the referral site upon all real estate transactions in which an enrolled alerted seller's real estate agent collects a commission on a sale of real estate by a seller who was referred to this enrolled seller's real estate agent by the referral site; and
rebating from the referral site to a referred real estate seller a portion of a referral fee earned from the enrolled alerted seller's real estate agent in respect of a qualifying real estate sale made by the referred real estate seller.

13. The method according to claim 12 further for providing a buyer of real estate with a partial rebate of buyer's real estate agent's commissions paid in a real estate transaction, the method further comprising:
enrolling at the referral site still other, buyer's, real estate agents who will pay a referral fee to the referral site upon their earning of buyer's real estate agent's sales commission on a real estate sale made to a real estate buyer referred to them by the referral site;
operating the referral site to refer identified potential buyers of real estate to enrolled buyer's real estate agents; while
alerting from the referral site enrolled buyer's real estate agents as to all referrals made of them, and to them, of potential buyers of real estate;
wherein a referral fee is collected by the referral site upon all real estate transactions in which an enrolled alerted buyer's real estate agent collects a commission on a purchase of real estate by a buyer who was referred to this enrolled buyer's real estate agent by the referral site; and
rebating from the referral site to a referred real estate buyer a portion of a referral fee earned from the enrolled alerted buyer's real estate agent in respect of a qualifying real estate purchase made by the referred real estate buyer.

14. The method according to claim 12 further comprising, including between the enrolling and the operating, the step of:
advertising the referral site as providing a rebate to sellers of real estate who do list and sell real estate using seller's brokers referred to them by the referral site.

15. The method according to claim 12
wherein the enrolling is at the referral site of a licensed real estate broker or agent.

16. A business method of providing a buyer of real estate, a seller of real estate, or both with a partial rebate of, respectively, buyer's real estate agent's commissions paid, seller's real estate agent's commissions paid, or both, in a real estate transaction, the method comprising:
enrolling at a site upon an international communications network seller's, or buyer's, or both seller's and buyer's real estate agents who will pay a referral fee to the site upon their earning of a respective seller's, or buyer's, or both seller's and buyer's real estate agent's sales commissions respectively on sales made to, and purchases made by, sellers and buyers of real estate that are referred to these agents by the site;
operating the site to refer identified potential sellers of real estate to enrolled seller's real estate agents, and identified potential buyers of real estate to enrolled buyer's real estate agents, and
alerting from the referral site enrolled seller's real estate agents, of buyer's real estate agents, or both, as to all referrals made of them, and to them, of, respectively, potential sellers and buyers of real estate;
wherein a referral fee is collected by the referral site upon all real estate transactions in which (1) an enrolled alerted seller's real estate agent collects a commission on a sale of real estate by a seller who was referred to this enrolled seller's real estate agent by the referral site, (2) an enrolled alerted buyer's real estate agent collects a commission on a purchase of real estate by a buyer who was referred to this enrolled buyer's real estate agent by the referral site, or transactions in which (3) both seller's agents and buyer's agents collect commissions from respective sellers and buyers of real estate on respective sellers and buyers referred to them by the referral site; and
rebating from the referral site to a referred real estate seller, or buyer, or both, a portion of a referral fee earned from the enrolled alerted respective seller's real estate agent, buyer's real estate agent, or both, in respect of a qualifying real estate transaction made by the referred respective real estate seller, or buyer, or both;
where a real estate seller, or buyer, or both may receive a rebate on the commissions of a respective seller's real estate agent, buyer's real estate agent, or both seller's and buyer's real estate agent from, and through, the referral site.

17. The method according to claim 16
wherein the enrolling is at the referral site of a licensed real estate broker or agent.
